(19) United States
(12) Patent Application Publication
(10) Pub. No.: US 2019/0106024 A1
(43) Pub. Date: Apr. 11, 2019

(54) INTERMEDIATE REAR ROW SEAT WITH VARIABLE POSITIONS FOR VEHICLE

(71) Applicant: GM GLOBAL TECHNOLOGY OPERATIONS LLC, Detroit, MI (US)

(72) Inventors: Carl W. Wellborn, Detroit, MI (US); Joseph Neighbors, Milford, MI (US); Raymond A. Beaufait, Macomb, MI (US)

(73) Assignee: GM GLOBAL TECHNOLOGY OPERATIONS LLC, Detroit, MI (US)

(21) Appl. No.: 15/729,834

(22) Filed: Oct. 11, 2017

(51) Int. Cl. B60N 2/20; B60N 2/02; B60N 2/46

(52) U.S. Cl. CPC B60N 2/206; B60N 2002/4425; B60N 2/4606; B60N 2/0224

(57) ABSTRACT

A vehicle includes a vehicle body and a rear row of seats attached to the vehicle body. The rear row of seats includes a first side seat proximate a first side of the vehicle, a second side seat proximate a second side of the vehicle, and an intermediate seat disposed between the first side seat and the second side seat. The intermediate seat has an upright position. The intermediate seat is configured to support an occupant in the upright position. The intermediate seat is supported for movement relative to the vehicle body, the first side seat, and the second side seat while in the upright position. Methods for positioning a rear row of seats are also disclosed.

### TECHNICAL FIELD

The technical field generally relates to a vehicle seating system, and more particularly relates to an intermediate rear row seat with variable positions for a vehicle.

### INTRODUCTION

Cars, SUVs, crossovers, trucks, vans, and other motor vehicles often include multiple rows of seating. In many cases, the rear row of seats (e.g., the second row or the third row of seats) is often utilized and, in some cases, is the more desirable seating choice. For example, in the case of a taxi or limousine ride, the rider(s) may prefer to sit in the rear row of seats. Likewise, a rider may prefer to sit in the rear row when riding in a driverless (i.e., autonomous) vehicle.

However, conventional rear row seating is limited. The rear row is often fixed to the vehicle body. Thus, the rear row of seats may become crowded and uncomfortable for the vehicle occupants.

Accordingly, it is desirable to provide a rear row seating assembly that is highly adjustable and convenient to use. Also, it is desirable to provide a system and method for automatically adjusting the rear row seating. Furthermore, other desirable features and characteristics of the present disclosure will become apparent from the subsequent detailed description and the appended claims, taken in conjunction with the accompanying drawings and the foregoing technical field and background.

### SUMMARY

A vehicle is disclosed that includes a vehicle body and a rear row of seats attached to the vehicle body. The rear row of seats includes a first side seat proximate a first side of the vehicle, a second side seat proximate a second side of the vehicle, and an intermediate seat disposed between the first side seat and the second side seat. The intermediate seat has an upright position. The intermediate seat is configured to support an occupant in the upright position. The intermediate seat is supported for movement relative to the vehicle body, the first side seat, and the second side seat while in the upright position.

Additionally, a method of controlling a position of an intermediate seat of a rear row of seating of a vehicle is disclosed. The method includes receiving, by a control system, a request for moving the intermediate seat relative to a vehicle body of the vehicle, a first side seat of the rear row, and a second side seat of the rear row while the intermediate seat is in an upright position. The method also includes generating, by the control system, a command based on the request. Furthermore, the method includes communicating, from the control system to an actuator of the vehicle, the command. Additionally, the method includes operating the actuator according to the command to move the intermediate seat relative to the vehicle body, the first side seat, and the second side seat while the intermediate seat is in the upright position.

Moreover, a system for controlling seating of vehicles is disclosed. The system includes a vehicle with a vehicle body and a rear row of seats with a first side seat, a second side seat, and an intermediate seat disposed between the first side seat and the second side seat. The vehicle also includes an actuator configured to actuate the intermediate seat relative to the vehicle body, the first side seat, and the second side seat. The system further includes a control system configured to receive a request for moving the intermediate seat relative to the vehicle body, the first side seat, and the second side seat. The control system is configured to generate a command based on the request, and the control system is configured to communicate the command to the actuator. The actuator is configured to operate according to the command to move the intermediate seat relative to the vehicle body, the first side seat, and the second side seat while the intermediate seat is in an upright position.

### BRIEF DESCRIPTION OF THE DRAWINGS

The exemplary embodiments will hereinafter be described in conjunction with the following drawing figures, wherein like numerals denote like elements, and wherein:

FIG. 1 is a side view of a vehicle in accordance with an embodiment of the present disclosure;

FIG. 2 is a front perspective view of a rear row of seats of the vehicle of FIG. 1 with an intermediate seat in accordance with an embodiment of the present disclosure;

FIG. 3 is a rear perspective view of the rear row of seats of FIG. 2;

FIG. 4 is a rear perspective view of the rear row of seats of FIG. 3 with the intermediate seat in a folded position in accordance with an embodiment of the present disclosure;

FIG. 5 is a front perspective view of the rear row of seats of FIG. 2 with a side seat in a folded position in accordance with an embodiment of the present disclosure;

FIG. 6 is a front perspective view an intermediate seat of a rear row of seats with deployable armrests in accordance with additional embodiments of the present disclosure;

FIG. 7 is a front perspective view of an intermediate seat of a rear row of seats with deployable armrests in accordance with additional embodiments of the present disclosure; and

FIG. 8 is a flowchart of a method of controlling vehicle seating in accordance with an embodiment of the present disclosure.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

The following discloses a seating system for a vehicle, such as a car, sport utility vehicle (SUV), crossover, truck, van, or other motor vehicle. The seating system may be included as a rear row of seating for the vehicle. In some embodiments, the rear row of seating includes a first side seat, a second side seat, and an intermediate seat (e.g., a middle seat) disposed between the first and second side seats. The intermediate seat may be supported for movement relative to the vehicle body (e.g., the chassis of the vehicle), the first side seat, and the second side seat while in an upright position. In some embodiments, the intermediate seat may move along a longitudinal axis of the vehicle (e.g., forward and rearward). This may allow the occupant to move the intermediate seat, for example, rearward relative to the side seats to create more shoulder room, hip room, and/or leg room. In additional embodiments, the intermediate seat may move vertically, creating more head room, or supporting the occupant higher within the vehicle for an improved vantage point.

One or more of the seats in the rear row may move automatically. For example, the intermediate seat may be moved automatically. A control system may be in communication with an actuator of the intermediate seat to provide controlled movement of the intermediate seat. Also, control commands for changing the position of the intermediate seat may be supplied from a component that is remote from the vehicle. Accordingly, the seating system may be incorporated, for example, within a taxi system, a ride share system, or other similar system, and the intermediate seat may be automatically positioned and configured for the rider before the vehicle arrives. Moreover, the seating system may be incorporated in an autonomous vehicle in some embodiments. As such, the vehicle seating system and its methods of use may enhance comfort and convenience when using the intermediate seat in the rear row.

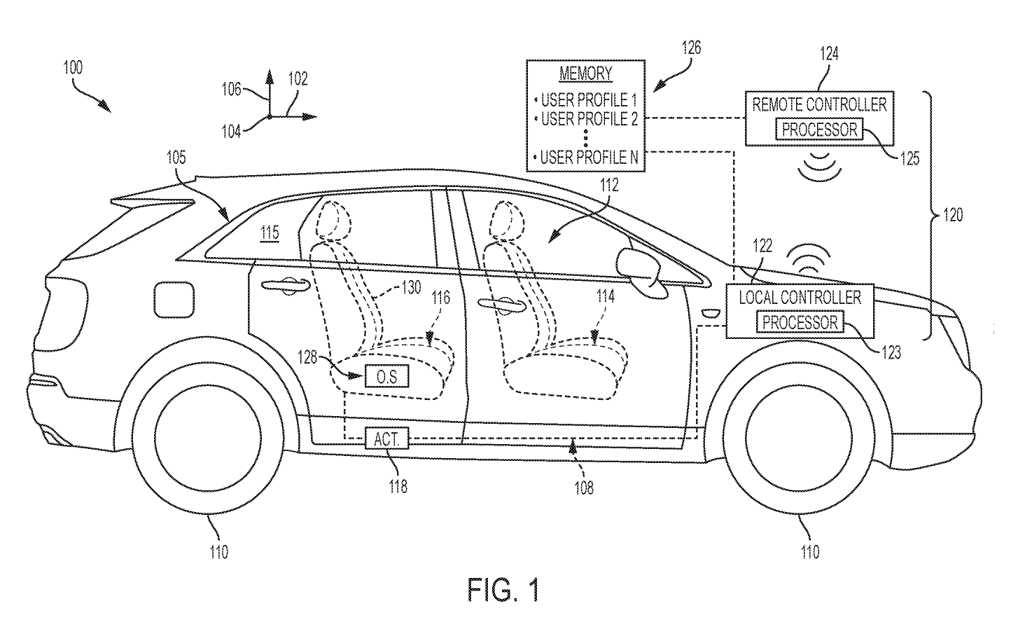

Referring now to FIG. 1, a vehicle 100 is illustrated according to example embodiments. The vehicle 100 may be an automobile of any suitable type, such as a car, sport utility vehicle (SUV), cross-over, station wagon, truck, van, etc. The vehicle 100 may define a longitudinal axis 102 (i.e., a roll axis) that extends between a front end and a rear end of the vehicle 100. The vehicle 100 may also define a lateral axis 104 (i.e., a pitch axis) that extends between a first side and an opposite second side of the vehicle 100, and which may be normal to the longitudinal axis 102. Additionally, the vehicle 100 may include a vertical axis 106 that is normal to both the longitudinal axis 102 and the lateral axis 104.

As shown, the vehicle 100 includes a vehicle body 108, which may comprise a chassis, frame, interior finishing, dashboard, doors, and other structures. The vehicle body 108 may be supported by a plurality of wheels 110 (e.g., front and rear wheels 110).

The vehicle body 108 may define a passenger compartment 112 configured to hold vehicle occupants. The vehicle 100 may also include a seating system 105 with at least one row of seats, such as a first row 114 (a front row of seats) and a second row 116 (a rear row of seats). The second row 116 is disposed rearward of the first row 114 along the longitudinal axis 102. The second row 116 may be disposed proximate the rear of the vehicle 100, and the first row 114 may be disposed proximate the front of the vehicle. In some embodiments, there may be a rear space 115 in back of the second row 116. The rear space 115 may be an enclosed trunk or boot that is isolated from the passenger compartment 112 in some embodiments. In additional embodiments, the rear space 115 may be open to the passenger compartment 112.

Although two rows are shown in FIG.1, it will be appreciated that the vehicle 100 may include more rows. For example, the vehicle 100 may include the first row 114 (front row), the second row 116 (middle row), and a third row (rear row), which is disposed rearward relative to the second row 116 along the longitudinal axis 102.

In some embodiments, the second row 116 may include at least one individual seat 130 that is independently moveable relative to another seat within the row and relative to the vehicle body 108. In some embodiments, the seat 130 may be moveable forward and backward along the longitudinal axis 102 and/or upward and downward along the vertical axis 106.

Also, the second row 116 may include one or more actuators 118 for automatically actuating the seat 130 relative to the other seat(s) in the rear row 116 and relative to the vehicle body 108. The actuator 118 may include an electric motor, a linear actuator, a hydraulic actuator, a pneumatic actuator, or other type, and may be attached to both the seat 130 and the vehicle body 108 (e.g., to the chassis of the vehicle 100).

Furthermore, the seating system 105 of the vehicle 100 may include a control system 120, which may be configured for generating control commands and communicating those commands to the actuator 118. Accordingly, movement of the seat(s) within the rear row 116 may be automated and controlled.

In some embodiments, the control system 120 may include a local controller 122, which includes a local processor 123. The local controller 122 may communicate with the actuator 118 via a wired and/or a wireless connection. The local processor 123 may generate control commands for the actuator 118 according to a request, and the actuator 118 may actuate the seat 130 according to the control commands. Additionally, the local controller 122 may be configured for controlling other vehicle components, such as the engine throttle, the braking system, the exhaust system, and/or other vehicle components. Accordingly, in some embodiments, the local controller 122 may be incorporated within the ECU or other controller of the vehicle. Moreover, the local controller 122 may be configured for controlling the vehicle 100 autonomously (i.e., without a human steering or otherwise driving the vehicle).

The control system 120 may further include a remote controller 124, which includes a remote processor 125. The remote processor 125 may generate control commands, for example, for actuating the actuator 118. In some embodiments, the remote controller 124 may communicate wirelessly with the local controller 122 via radio communication, Bluetooth, Wi-Fi, cellular communication, or other communication protocol. The remote controller 124 may generate and send control commands to the local controller 122, and the local controller 122 may communicate corresponding commands to the actuator 118 for ultimately moving the seat 130 of the rear row 116.

Furthermore, in some embodiments, the control system 120 may include and/or may be in communication with a computerized memory element 126. The memory element 126 may be included in and local to the vehicle 100 in some embodiments. In additional embodiments, the memory element 126 may be remote from the vehicle 100. In some embodiments, the memory element 126 may include stored data, such as stored user information. For example, the memory element 126 may include one or more user profiles, which are labelled “user profile 1”, “user profile 2”, and “user profile N” in FIG. 1. The user profiles may represent one or preferences of a particular user. For example, at least one user profile may represent that user's preferences as to seat position for the seat 130. Accordingly, as will be discussed, the memory element 126 may be utilized for recalling and automatically positioning the seat 130 within the vehicle 100 according to the preferences of a particular user.

Moreover, the control system 120 may include and/or may be in communication with an occupant sensor 128. The occupant sensor 128 may be configured for detecting whether one or more seats in the rear row 116 are occupied. The occupant sensor 128 may comprise a Hall effect sensor mounted within the seat, an optical sensor (e.g. a camera or laser), or other type. The control system 120 may be in communication with the occupant sensor 128 and may generate control commands according to whether the seat(s) are occupied or unoccupied, according to which seat(s) are occupied, and the like. Accordingly, the control system 120 may take occupancy into consideration when positioning the seat 130 in some embodiments.

Thus, the seating system 105 of the present disclosure may provide a seat 130 in the rear row 116 of the vehicle 100 that provides ample room and comfort for the occupants. The seat 130 may be actuated automatically for added convenience. Also, the seating system 105 may be configured for taxi, limousine, ride-share, and/or autonomous riding scenarios.

These concepts and features will be discussed in greater detail below according to exemplary embodiments of the present disclosure. It will be appreciated that the vehicle 100, the control system 120, and the methods of use may vary from those discussed without departing from the scope of the present disclosure. Before discussing the embodiments in detail, several terms and their meanings are explained.

As used herein, the term “module” refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the vehicles and the control systems and methods described herein are merely exemplary embodiments of the present disclosure.

Conventional techniques related to signal processing, data transmission, signaling, control, and other functional aspects of the systems (and the individual operating components of the systems) may not be described in detail herein for brevity. Furthermore, the connecting lines and other groupings shown in the various figures contained herein are intended to represent example functional relationships and/or physical couplings between the various elements. It should be noted that many alternative or additional functional relationships or physical connections may be present in an embodiment of the present disclosure.

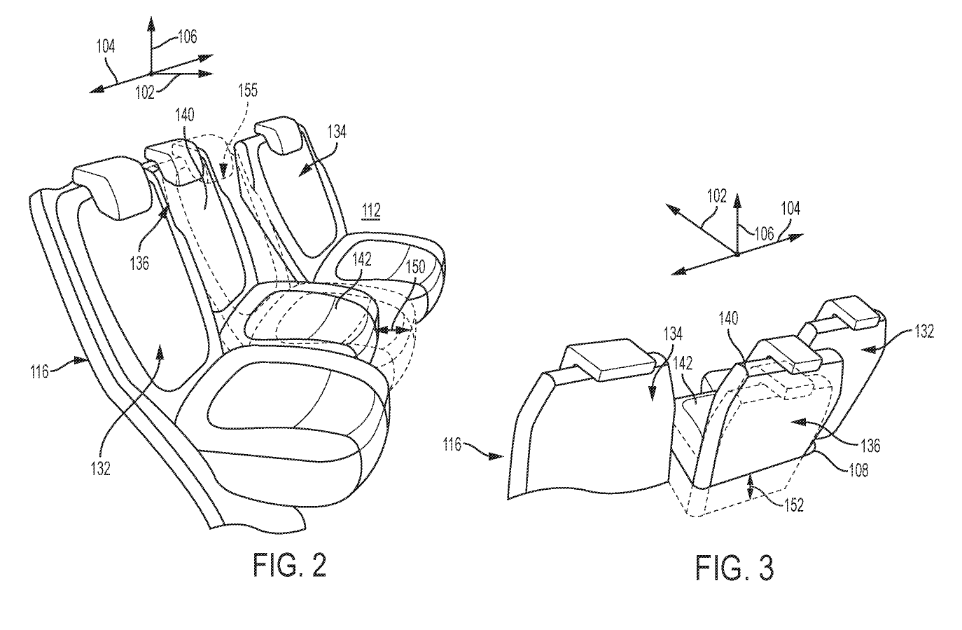

Referring now to FIGS. 2, 3, and 4, the rear row 116 of seats is shown according to example embodiments. As shown, the rear row 116 may include a first side seat 132 proximate a first side of the vehicle 100 (e.g., a driver side) and a second side seat 134 proximate an opposite second side of the vehicle 100 (e.g., a passenger side). The rear row 116 may further include an intermediate seat 136 disposed between the first and second side seats 132, 134 with respect to the lateral axis 104 of the vehicle 100.

The first side seat 132, the intermediate seat 136, and/or the second side seat 134 may include contoured portions that conform to the contours of the human body, a recess for receiving the back and/or posterior of the rider, etc. The seats 132, 134, 136 may also include cushioning materials, or other similar features for added comfort. Furthermore, the seats 132, 134, 136 may include seat belts, airbags, or other restraints for occupant safety.

In some embodiments, the first side seat 132, the intermediate seat 136, and the second side seat 134 may occupy substantially the entire width of the passenger compartment 112 of the vehicle 100 with respect to the lateral axis 104. Also, in some embodiments, the intermediate seat 136 may occupy between approximately 40% and 50% of the width of the passenger compartment 112, whereas the first and second side seats 132, 134 may each occupy between approximately 25% and 30% of the width of the passenger compartment 112.

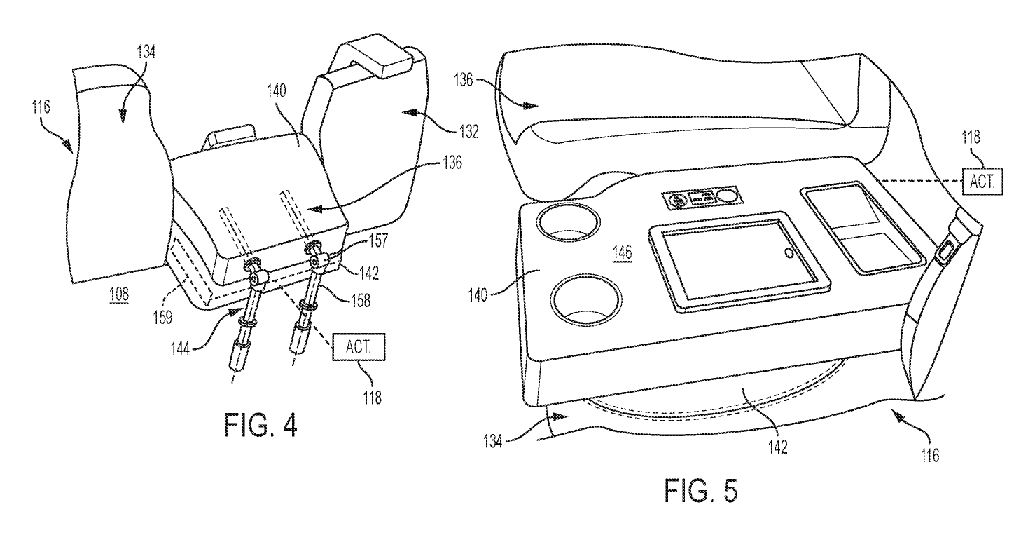

In some embodiments, the first side seat 132, the intermediate seat 136, and the second side seat 134 may include a respective seatback 140 and a base 142. The seatback 140 may be configured for supporting an occupant's back and shoulders, and the base 142 may be configured for supporting the occupant's posterior. In some embodiments, the seatback 140 may have various positions relative to the respective base 142. For example, as shown in FIGS. 2 and 3, the intermediate seat 136 may have an upright position in which the seatback 140 extends substantially vertically from a rear side of the base 142. As shown in FIG. 4, the intermediate seat 136 may also have a folded position in which the seatback 140 is layered over the seatback 140. Moreover, as shown in FIG. 5, one or more of the seatbacks 140 of the side seats (here, the seatback 140 of the second side seat 134) may have a folded position as well. It will be appreciated that the seats may support an occupant when in the upright position. The seats may be moved to the folded position, for example, for storage and/or increasing available space within the passenger compartment 112 of the vehicle 100.

As shown in FIG. 5, one or more of the seatbacks 140 may be configured as a work surface 146. The work surface 146 may be accessible when the seat is in the folded position. In some embodiments, the work surface 146 may include a writing surface, cup holders, touch-sensitive displays, electrical outlets, etc. In the embodiment shown, the second side seat 134 may include the work surface 146 on back of the seatback 140. It will be appreciated that the first side seat 132 may include a similar work surface 146 in some embodiments. As such, the occupant of the intermediate seat 136 may utilize the work surface 146 while riding in the vehicle 100.

Referring to FIG. 4, the first side seat 132, the intermediate seat 136, and/or the second side seat 134 may respectively include a support structure 144 (FIG. 3). The support structure 144 may include brackets, fasteners, sliders, hinges, telescoping structures, or other structures for attaching the respective seat 132, 136, 134 to the vehicle body 108. In some embodiments, the support structure 144 may also attach the seatback 140 to the respective base 142. In some embodiments, the support structure 144 may support the respective seat for movement relative to the vehicle body 108 and the other seats.

For example, the support structure 144 of the intermediate seat 136 may include a seatback support structure 158. The seatback support structure 158 may include a plurality of rods. At least one rod may be attached to the vehicle body 108 (e.g., the floor structure of the vehicle body 108), another rod may be attached to and received within the seatback 140, and the rods may be rotatably attached via a hinge 157. The seatback support structure 158 may support movement of the seatback 140 between the upright position (FIGS. 2 and 3) and the folded position (FIG. 4).

The support structure 144 of the intermediate seat 136 may further include a base support structure 159. The base support structure 159 may include a part that is attached to the vehicle body 108 (e.g., the floor structure of the vehicle body 108), and another part may be attached to the base 142 such that the base support structure 159 attaches the base 142 to the vehicle body 108. The base support structure 159 may include a slider bracket, a scissor-lift bracket, or other structure that supports movement of the base 142. The base support structure 159 may support movement of the base 142 relative to the vehicle body 108, the first side seat 132, and the second side seat 134. Also, the base support structure 159 may be attached either directly or indirectly to the seatback support structure 158. As such, the base support structure 159 or another part of the support structure 144 may support the base 142 and the seatback 140 for movement as a unit when in the upright position of FIGS. 2 and 3. Thus, the intermediate seat 136 may move relative to the vehicle body 108, the first side seat 132, and the second side seat 134 when in the upright position.

For example, as shown in FIG. 2, the intermediate seat 136 may move between a forward position (shown in phantom) and a rearward position (shown in solid lines) along the longitudinal axis 102 as represented by longitudinal arrow 150. When in the forward position, the seatback 140 of the intermediate seat 136 as well as the front end of the base 142 may be substantially flush with those of the first side seat 132 and the second side seat 134. Accordingly, in the forward position, the rear row 116 may appear to be substantially continuous and uninterrupted along the lateral axis 104. In contrast, when in the rearward position, the seatback 140 and the front end of the base 142 may be disposed rearward of those of the first and second side seats 132, 134. When in the rearward position, the seatback 140 may be spaced apart at a distance to define a longitudinal gap 155 between the adjacent seatbacks 140 of the first and second side seats 132, 134. The gap 155 may provide increased room for the hips, thighs, arms, and/or shoulders of the occupant of the intermediate seat 136. Also, in the rearward position, the base 142 may provide increased legroom for the occupant.

Moreover, as shown in FIG. 3, the intermediate seat 136 may move between a lowered position (shown in phantom) and a raised position (shown in solid lines) along the vertical axis 106 as represented by vertical arrow 152. (For purposes of clarity, FIG. 3 shows the intermediate seat 136 in the rearward position with respect to the longitudinal axis 102 as well as being raised and lowered with respect to the vertical axis 106.) When in the lowered position, the intermediate seat 136 may be substantially level with the first side seat 132 and the second side seat 134. In contrast, in the raised position, the base 142 and the seatback 140 may be disposed above those of the first and second side seats 132, 134 with respect to the vertical axis 106. Accordingly, the intermediate seat 136 may be raised to provide an improved vantage point for the occupant from within the vehicle 100.

In some embodiments, the intermediate seat 136 may be supported for simultaneously moving along both the longitudinal axis 102 and the vertical axis 106 while in the upright position. Accordingly, the intermediate seat 136 may provide a wide range of positions within the passenger compartment 112.

Furthermore, the actuator 118 (mentioned above in relation to FIG. 1) may be operably attached to the support structure 144 for moving the intermediate seat 136. The actuator 118 may move the intermediate seat 136 between the forward and rearward positions (FIG. 2), between the raised and lowered positions (FIG. 3), and/or between the folded and upright positions (FIG. 4). Accordingly, these movements may be automated for added convenience. As mentioned above in the discussion of FIG. 1, the actuator 118 may be in communication with the control system 120. The processor 123 of the local controller 122 may generate control commands that are sent to the actuator 118 for moving the intermediate seat 136. This may occur, for example, in response to a user input (e.g., an occupant within the seat 136 pressing a button, etc.). Also, in some embodiments, the processor 125 of the remote controller 124 may generate control commands that are sent to the local controller 122, which relays a corresponding command to the actuator 118 to ultimately move the seat 136.

As shown in FIG. 5, a similar actuator 118 may be operably attached to the second side seat 134 (and/or the first side seat 132) for moving the seatback 140 to the folded position. The control system 120 may be in communication with and may control the actuator 118. In some embodiments, the first side seat 132, the second side seat 134, and the intermediate seat 136 may each have a respective actuator for automatically adjusting the position of the seat relative to the others.

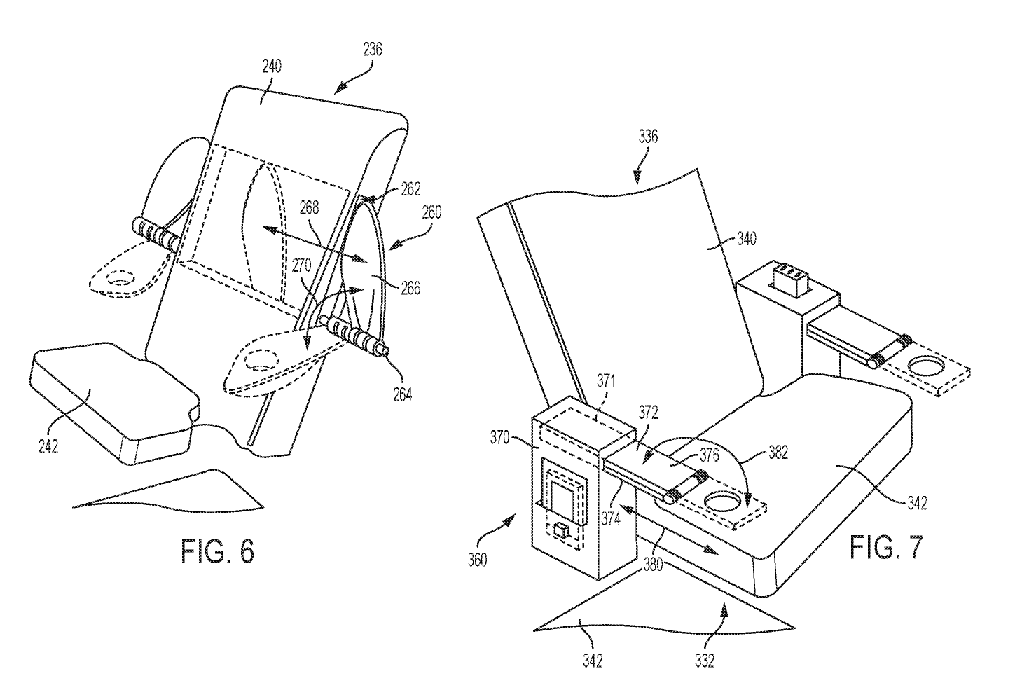

Referring now to FIG. 6, additional embodiments of the intermediate seat 236 will be discussed according to example embodiments. The intermediate seat 236 may include features discussed above with respect to the embodiments of FIGS. 1-5. Discussion of those features will not be repeated for purposes of brevity. Components that correspond to those of FIGS. 1-5 are indicated with corresponding reference numbers increased by 100.

As shown, the intermediate seat 236 may include one or more armrests 260. For example, the seat 236 may include armrests 260 on opposite sides of the seatback 240. Each armrest 260 may include a rest member 266, which is generally wide and flat and configured to support the occupant's forearm. The rest member 266 may also include a cup holder or other ergonomic features. The armrest 260 may also include a support structure 264, such as a rod that attaches the rest member 266 to the seatback 240.

In some embodiments, support structure 264 may support the rest member 266 for movement relative to the seatback 240. For example, the support structure 264 and the rest member 266 may move as a unit linearly in the lateral direction relative to the side of the seatback 240 as indicated by arrow 268. Also, the rest member 266 may rotate about the axis of the support structure 264 as indicated by arrow 270.

Furthermore, in some embodiments, the seatback 240 may include an aperture 262 configured to receive at least part of the armrest 260. The aperture 262 may be an internal cavity within the seatback 240 that extends across a width of the seatback 240 and that is open at the side of the seatback 240. In other embodiments, the aperture 262 may be a recessed surface on the back side of the seatback 240. The aperture 262 may be configured to receive both armrests 260 of the intermediate seat 236.

In some embodiments, the armrest 260 may have a retracted position (shown in phantom) in which the rest member 266 and the support structure 264 are disposed within the aperture 262. The armrest 260 may also have an intermediate position (shown in solid lines) in which the support structure 264 and the rest member 266 are disposed outside the aperture 262 and the rest member 266 extends vertically from the support structure 264. Moreover, the armrest 260 may have an extended or deployed position (shown in phantom) in which the support structure 264 and rest member 266 are disposed outside the aperture 262 and the rest member 266 extends horizontally and forward from the support structure 264.

Accordingly, the armrests 260 may move to the retracted position for storage when the intermediate seat 236 is in the forward position relative to the side seats and/or when the side seats are upright. In contrast, the armrests 260 may move to the extended position to support the occupant's arms when the intermediate seat 236 is in the rearward position relative to the side seats and/or when the side seats are folded down. In some embodiments, the armrest 260 may be connected to an actuator and control system for automatic and controlled movement as well.

Referring now to FIG. 7, additional embodiments of the intermediate seat 336 will be discussed according to example embodiments. The intermediate seat 336 may include features discussed above with respect to the embodiments of FIGS. 1-5. Discussion of those features will not be repeated for purposes of brevity. Components that correspond to those of FIGS. 1-5 are indicated with corresponding reference numbers increased by 200.

As shown, the intermediate seat 336 may include armrests 360 with multiple deployable portions, such as a first portion 370 and a second portion 372. The first portion 370 may be block-shaped and may be attached to the base 342 of the seat 336, proximate the seatback 340. The second portion 372 may be moveably attached to the first portion 370 and may move linearly in and out of the first portion 370 as indicated by arrow 380.

In some embodiments, the first portion 370 may be fixed to the base 342 and may be received between the base 342 and the adjacent base 342 of the side seat 332 to allow the intermediate seat 336 to move relative to the side seat 332. In other embodiments, the first portion 370 may be moveably mounted to the base 342 of the intermediate seat 336. For example, the first portion 370 may move linearly and vertically between a retracted (stowed) and an extended (deployed) position relative to the base 342. Similarly, in some embodiments, the first portion 370 may move angularly between the retracted and extended positions. Furthermore, the first portion 370 may include one or more apertures, such as pockets, cavities, etc. for holding the occupant's possessions. The first portion 370 may additionally include an aperture 371 that is configured to receive the second portion 372 of the armrest 360.

The second portion 372 may include a base 374 and an extension 376. The base 374 may be moveably attached to the first portion 370 for sliding in and out of the first portion 370 along the direction indicated by arrow 380. The extension 376 may be hingeably attached to the base 374 for rotating along the direction indicated by arrow 382. As such, the extension 376 may rotate between a retracted position (shown in solid lines), in which the extension 376 is layered on the base 374, and an extended position (shown in phantom), in which the extension 376 is rotated away from the base to extend the armrest 360 forward. Additionally, the extension 376 may include a cupholder for the occupant's convenience.

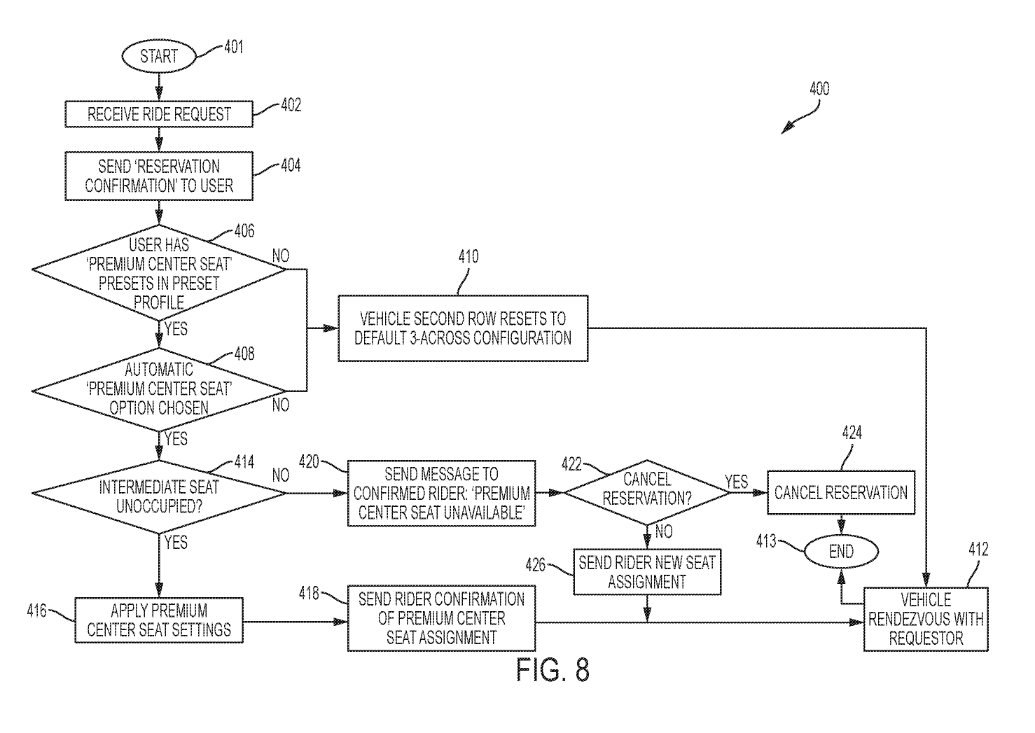

Referring now to FIG. 8, a method 400 for controlling positioning of the intermediate seat 136 is illustrated according to example embodiments. In some embodiments, the method 400 may be used for taxi services, chauffeur services, or ride-share services (i.e., where a person requests a ride in the vehicle 100). The vehicle 100 may also be an autonomous (driverless) vehicle in some embodiments. Moreover, the method 400 may be utilized in connection with a fleet of vehicles, one of which is illustrated in FIG. 1. As will be discussed, the method 400 may be utilized such that the rear row of seating 116 is automatically positioned before the vehicle 100 arrives to pick up the rider.

The method 400 may begin at 401, and at 402, the remote controller 124 may receive a ride request from a user. In some embodiments, the user may request the ride electronically via a smart-phone app or through another system. In some embodiments, the user may utilize the app to input his or her current geographical location, desired vehicle types, or other particulars. The request may also include specifications on how to arrange the vehicle seats. In other embodiments to be discussed, the system may rely on pre-stored user preferences within in the memory element 126 for dictating seating position within the vehicle 100.

Then, at 404, the remote processor 125 may process the request, and the remote controller 124 may reply, confirming the request received at 402. For example, the remote controller 124 may send a message via the smart-phone app back to the user that the request is received and that the vehicle 100 is on its way for pickup.

Next, at 406, the remote processor 125 may access the memory element 126 and identify whether there exists a user profile stored for the particular user. If there is, the remote processor 125 may determine whether the user profile includes presets related to the intermediate seat 136. For example, the remote processor 125 may determine whether the user profile includes settings for the position of the intermediate seat 136 within the vehicle 100.

If not (negative determination at 406), then the method 400 may continue at 410, and the rear row 116 may be positioned with the intermediate seat 136 in the forward and lowered position with respect to the first and second side seats 132, 134. In some embodiments, this may represent a default position of the seats 132, 134, 136 of the rear row 116. Next, at 412, the vehicle 100 may rendezvous with the rider with the rear row 116 in this default position, and the method 400 may terminate at 413.

If, however, the user profile does include presets (affirmative determination at 406), then the method may continue at 408. At 408, the remote processor 125 may determine whether the user prefers to sit in the intermediate seat 136. For example, the smart-phone app used to make the initial request at 402 may include an option for the user to select a “premium center seat” position for the intermediate seat 136. If the user has not made this selection (negative determination at 408), then the method 400 may continue to 410, 412, and 413 as described above. In contrast, if the user made this selection (affirmative determination at 408), then the method 400 may continue at 414.

At 414, the control system 120 may determine whether the intermediate seat 136 is currently occupied. For example, the remote controller 124 may send a signal to the local controller 122, which may, in turn, utilize the occupant sensor 128 (FIG. 1) to detect whether the intermediate seat 136 is occupied. The occupant sensor 128 may respond with a corresponding signal, and the local controller 122 may relay the result back to the remote controller 124. If the seat 136 is unoccupied (positive determination at 414), then the system may allow re-positioning of the intermediate seat 136, and the method 400 may continue at 416. In contrast, if the seats are occupied (negative determination at 414), then the system may prevent re-positioning of the intermediate seat 136, and the method 400 may continue at 420.

At 416, the intermediate seat 136 may be re-positioned. For example, the remote controller 124 may communicate to the local controller 122 the user's preferred position for the intermediate seat 136. Then, the local processor 123 may generate and send control commands to the actuator 118 for moving the intermediate seat 136 to the position indicated in the user profile stored in the memory element 126. In the meantime, at 418, the remote controller 124 may send a message to the user that the intermediate seat 136 is available and assigned to that user. Then, at 412, the vehicle 100 may rendezvous with the user with the intermediate seat 136 already in the preferred position, and the method 400 may terminate at 413.

At 420, the remote controller 124 may send a message to the user (e.g., via the smart-phone app) that the intermediate seat 136 is unavailable. Next, at 422, the method 422 may allow the user to cancel the ride request. The remote controller 124 may output a command to send a cancellation inquiry to the user. If the user responds with a cancellation (affirmative result at 422), then at 424 the remote controller 124 may cancel the request sent at 402, and the method 400 may terminate at 413. If the user fails to respond or indicates that the ride request should be maintained, then the method 400 may continue at 426.

At 426, the remote controller 124 may assign the user a seat other than the intermediate seat 136. In some embodiments, the remote processor 125 may assign seating according to the output from the occupant sensor 128 received at 414. Then, at 412, the vehicle 100 may rendezvous with the user, and the method 400 may terminate at 413.

It will be appreciated that the method 400 may vary from these embodiments without departing from the scope of the present disclosure. For example, the method 400 may include detecting which of the seats in the rear row 116 are occupied. If one or more of the side seats 132, 134 are occupied and the intermediate seat 136 is unoccupied, then the remote controller 124 may move the intermediate seat 136 to the rearward position and/or the vertical position to provide additional hip and shoulder space for the occupants in the rear row 116. Moreover, if one or more of the side seats 132, 134 are unoccupied, then the seatback may be folded down before the vehicle arrives. This may allow the user to more easily enter the vehicle 100 and/or may provide ergonomic work space for the rider as he or she sits in the intermediate seat 136. In these cases, the control command(s) sent by the remote controller 124 for the rear row 116 of seats may be dependent on which seats are occupied (as detected by the occupant sensor 128). In other words, different control commands may be issued according to the occupancy (number of passengers, seating location) of the vehicle 100.

It will also be appreciated that the method 400 may include automatic positioning of the armrests 260, 360 of FIGS. 6 and 7. For example, the default position of the armrests 260, 360 may be the stowed position. The intermediate seat 236, 336 may be controlled automatically as described above, and the armrests 260, 360 may be automatically actuated from the stowed position toward the extended (deployed) position as the intermediate seat 236, 336 moves. Additionally, the user profile may include preferences regarding the armrests 260, 360, and the system may be used for automatically controlling the position of the armrests 260, 360 according to those preferences.

In summary, the present disclosure provides a rear row of seats, a system for controlling positioning of one or more seats within the rear row, and a method for moving the seat(s) in a useful and convenient manner. In some embodiments, the vehicle, the system, and the methods of the present disclosure may be used for an intermediate seat of a rear row of seating. The vehicle seating system and its methods of use may enhance comfort and convenience when using the intermediate seat in the rear row.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A vehicle comprising:
a vehicle body; and
a rear row of seats attached to the vehicle body, the rear row of seats including:
a first side seat proximate a first side of the vehicle;
a second side seat proximate a second side of the vehicle;
an intermediate seat disposed between the first side seat and the second side seat, the intermediate seat having an upright position, the intermediate seat configured to support an occupant in the upright position, the intermediate seat supported for movement relative to the vehicle body, the first side seat, and the second side seat while in the upright position.

2. The vehicle of claim 1, wherein the intermediate seat is supported for movement between a forward position and a rearward position along a longitudinal axis of the vehicle;
wherein the intermediate seat, the first side seat, and the second side seat respectively include a base and a seatback;
wherein the seatback of the intermediate seat, in the rearward position, is disposed rearward of the seatback of at least one of the first side seat and the second side seat.

3. The vehicle of claim 2, wherein the seatback of the intermediate seat, in the forward position, is substantially flush with the seatback of the first side seat and the seatback of the second side seat; and
wherein the seatback of the intermediate seat, in the rearward position, is spaced apart at a distance measured along the longitudinal axis relative to the seatback of the first side seat and the seatback of the second side seat.

4. The vehicle of claim 1, wherein the intermediate seat is supported for movement along a vertical axis of the vehicle relative to the vehicle body, the first side seat, and the second side seat.

5. The vehicle of claim 1, wherein the intermediate seat includes an armrest that is supported for movement between an extended position and a retracted position.

6. The vehicle of claim 5, wherein the intermediate seat includes a seatback with an aperture;
wherein the armrest, in the extended position, is disposed outside the aperture; and
wherein the armrest, in the retracted position, is at least partially received within the aperture.

7. The vehicle of claim 5, wherein the armrest includes a first portion and a second portion that are configured to support at least a portion of an arm of the occupant;
wherein the first portion supports the second portion for movement between a stowed position and a deployed position.

8. The vehicle of claim 1, wherein the intermediate seat includes a seatback and a base; and
further comprising a support structure that attaches the base to the vehicle body; and
wherein the support structure supports the seatback and the base for movement as a unit relative to the vehicle body, the first side seat, and the second side seat.

9. The vehicle of claim 1, wherein at least one of the first side seat and the second side seat includes a seatback and a base;
wherein the seatback is supported for movement relative to the base between an upright position and a folded position; and
wherein the seatback includes a work surface for the occupant when in the folded position.

10. The vehicle of claim 1, further comprising:
an actuator that is configured to actuate the intermediate seat relative to the vehicle body, the first side seat, and the second side seat; and
a controller with a processor configured to generate a command for the actuator for moving the intermediate seat.

11. A method of controlling a position of an intermediate seat of a rear row of seating of a vehicle, the method comprising:
receiving, by a control system, a request for moving the intermediate seat relative to a vehicle body of the vehicle, a first side seat of the rear row, and a second side seat of the rear row while the intermediate seat is in an upright position;
generating, by the control system, a command based on the request;
communicating, from the control system to an actuator of the vehicle, the command;
operating the actuator according to the command to move the intermediate seat relative to the vehicle body, the first side seat, and the second side seat while the intermediate seat is in the upright position.

12. The method of claim 11, wherein operating the actuator includes operating the actuator to move the intermediate seat along a longitudinal axis of the vehicle relative to the vehicle body, the first side seat, and the second side seat.

13. The method of claim 11, wherein operating the actuator includes operating the actuator to move the intermediate seat along a vertical axis of the vehicle relative to the vehicle body, the first side seat, and the second side seat.

14. The method of claim 11, wherein communicating the command includes wirelessly communicating the command from the control system to the actuator.

15. The method of claim 14, wherein the control system includes a processor that is remote from the vehicle; and
wherein the processor is configured to generate the command.

16. The method of claim 15, further comprising accessing, by the processor, a memory element of the control system, the memory element including stored user information;
wherein generating the command includes generating the command based on the request and based on the stored user information stored on the memory element.

17. The method of claim 15, further comprising determining, by the control system, whether a seat of the rear row is occupied, the seat being one of the first side seat, the second side seat, and the intermediate seat;
further comprising communicating, from the control system to the vehicle, a first command in accordance with determining that the seat is occupied; and
further comprising communicating, from the control system to the vehicle, a second command in accordance with determining that the seat is unoccupied.

18. The method of claim 17, further comprising:
generating, by the processor, the first command in accordance with determining that the seat is occupied;
outputting, by a user output device of the vehicle, a user message according to the first command;
generating, by the processor, the second command in accordance with determining that the seat is unoccupied; and
operating the actuator according to the second command to move the intermediate seat.

19. A system for controlling seating of vehicles comprising:
a vehicle including:
a vehicle body;
a rear row of seats with a first side seat, a second side seat, and an intermediate seat disposed between the first side seat and the second side seat; and
an actuator configured to actuate the intermediate seat relative to the vehicle body, the first side seat, and the second side seat;
a control system configured to receive a request for moving the intermediate seat relative to the vehicle body, the first side seat, and the second side seat, the control system configured to generate a command based on the request, the control system configured to communicate the command to the actuator; and
the actuator configured to operate according to the command to move the intermediate seat relative to the vehicle body, the first side seat, and the second side seat while the intermediate seat is in an upright position.

20. The system of claim 19, wherein the control system includes a processor that is remote from the vehicle;
wherein the control system includes a memory element having stored user information; and
wherein the processor is configured to generate the command based on the request and based on the stored user information stored on the memory element.
